(19) United States
(12) Patent Application Publication
(10) Pub. No.: US 2007/0275749 A1
(43) Pub. Date: Nov. 29, 2007

(54) Method For Data Reception In A Multi-Function Receiving Device

(75) Inventors: Larri Vermola, Turku (FI); Tuomo Saarikivi, Helsinki (FI)

Correspondence Address: MORGAN & FINNEGAN, L.L.P., 3 WORLD FINANCIAL CENTER, NEW YORK, NY, 10281-2101, US

(73) Assignees: Larri VERMOLA, Turku (FI); NOKIA CORPORATION, Espoo (FI)

(21) Appl. No.: 10/580,677

(22) PCT Filed: Oct. 18, 2004
(86) PCT No.: PCT/IB04/52123

§ 371 Date: Mar. 8, 2007

(30) Foreign Application Priority Data
Dec. 5, 2003 (GB) 0328249.8

(51) Int. Cl. H04M 1/00

(52) U.S. Cl. 455/550.1

(57) ABSTRACT

A data receiving device (2a) is arranged to run a media guide application through which a user may access a service provided over broadcast network (3). Should reception of the service be interrupted, for example, by an incoming telephone call over telecommunications network (4), the data receiving device (2a) operates in a first resource saving mode where data is received by receiver (11) but neither processed nor output. The received data may be stored for later output or simply discarded. The service can then be resumed, with minimal delay, by restarting processing and outputting of received data, as it is not necessary to reactivate or resynchronise the receiver (11). After operating in said first resource saving mode for a predetermined time period, the receiver (11) may be deactivated in order to further save power. Applications used in receiving, processing and/or outputting the received data, may be closed down following the expiry of one or more further predetermined time periods.

### BACKGROUND OF THE INVENTION

The invention relates to a receiving device and method for receiving data that is particularly suitable for reception of digital services over a wireless link.

Proposed services for mobile terminals, such as news, entertainment or business services, require the transmission of content to one or more receiving devices. The content may include audio, video, multimedia, graphic or other data, such as music files or film clips. However, a considerable amount of data is required to provide such services, and the reception and processing of this data may place significant demands on the restricted power and memory capacities of a mobile terminal.

In particular, a mobile terminal may be required to run an unrelated application while receiving a service. For example, where the mobile terminal comprises a telephone handset, it may be required to handle an incoming call while receiving a data stream or, alternatively, a user may wish to access an application such as a calendar or notepad etc. Applications that are local to the mobile terminal can be suspended, for example, by saving a set of current parameters for subsequent use in resuming the application. However, the suspension of a service received from an external source is more problematical as the service itself is not interrupted and transmission of the data stream continues. In this situation, a service receiving part of the mobile terminal may close down reception of the service but, should the user wish to return to the service, this may require data reception, processing and outputting applications to be set up and started again, causing delay and inconvenience. Alternatively, the mobile terminal may continue to receive and process the data stream while the unrelated application is running. This wastes power, particularly as a large proportion of the power consumption in such a mobile terminal is due to the demands of a receiver when receiving data transmissions, and may be problematical as mobile terminals are typically powered by a battery of limited capacity. In addition, the reception and processing of data also requires processing resources, including memory, and prevent sufficient resources being available for handling the unrelated application.

### SUMMARY OF THE INVENTION

According to a first aspect of the invention, a data receiving device comprises receiving means arranged to receive data from a broadcast network, processing means for processing the received data and output means for outputting processed data and is arranged to operate in a first resource saving mode in which the receiving means remain active but received data is not processed by the processing means and not outputted by the output means.

The data receiving device may be arranged so that, when in the first resource saving mode, received data is discarded or saved in a memory without being processed or output. In this manner, resources within the data receiving device that would have been used for processing and outputting the received data, such as memory and processing time, are freed up for use by an unrelated application.

A data receiving device arranged to save received data when in the first resource saving mode may be configured so that, following the expiry of a predetermined time limit, any further received data is discarded without being saved. The predetermined time limit may be set by a user of the data receiving device.

As the receiving means remain active, should such a data receiving device, when operating in the first resource saving mode, be required to resume outputting received data, reactivation and resynchronization of the receiving means is not required. Therefore, processing and output of received data may be resumed with minimal delay.

The data receiving may be configured to, after operating in said first resource saving mode for a first predetermined time period, operate in a second resource saving mode in which the receiving means is deactivated while the processing means and output means remain operational. The deactivation of the receiving means reduces demand placed on a source supplying power to the receiving means.

Such a data receiving device may further be configured to, after operating in the second resource saving mode for one or more further predetermined time periods, perform one or more of the following steps: deactivate an application for outputting processed data via the output means, close an IP session configured to handle the output data and/or remove a filter means arranged to extract selected data from the received data for processing. For example, the data receiving device may be arranged to, after a second predetermined period of time, deactivate an application for outputting data via the output means, close the IP session and remove the filter means. In another example, the receiving device may be arranged to perform these actions in two or more stages, each stage being carried out after the expiry of an associated further predetermined time period.

The data receiving device may be configured to operate in the first resource saving mode following an interruption. An interruption may arise, for example, from the activation of an application in the data receiving device that is unrelated to reception of data from the broadcast network. The data receiving device may be arranged so that, in such a case, it operates in the first resource saving mode in response to a determination that insufficient resources are available for handling reception of data and the unrelated application. Where the data receiving device comprises a telephone transceiver arranged to transmit and receive data via a telecommunications network, an interruption may arise due to reception of an incoming telephone call from the telecommunications network.

The data receiving device may be arranged to execute a media guide application for selectively accessing services provided over broadcast network. The media guide application may be configured to display and, if required, update a list of available services on a user interface of the data receiving device.

The output means may comprise one or more of a display for outputting visually displayable data and audio output means. The audio output means may be integral to the data receiving device or arranged to provide data to an external speaker, an earphone or headphones connected to, or in wireless communication with, the data receiving device.

The invention also provides a communication system comprising a broadcast network and one or more receiving devices as described above. The communication system may further include a bi-directional telecommunications network, where at least one of the one or more data receiving devices comprises a telephone transceiver arranged to transmit and receive data via said telecommunications network.

According to a second aspect of the invention, a method of receiving data comprises receiving data from a broadcast network, processing the received data, outputting the processed data and, in response to an interruption, proceeding in a first resource saving mode by continuing to receive data from the broadcast network but not processing and not outputting said received data.

The received data may be stored or simply discarded. Where the received data is stored, the method may comprise discarding data received following the expiry of a predetermined time limit.

The method may further comprise, after proceeding in said first resource saving mode for a first predetermined time period, proceeding in a second resource saving mode in which no data is received from the broadcast network. The method may comprise operating in one or more further resource saving modes following the expiry of one or more corresponding further predetermined time periods.

The step of receiving data from the broadcast network may comprise filtering the received data in order to discard unwanted data. The method may comprise removing a filter arranged to perform said filtering step after operating in a further resource saving mode following the expiry of a further predetermined time period.

The method may further comprise displaying a list of services provided over the broadcast network and, optionally, updating said list of services and displaying an updated list.

This aspect also provides a computer program comprising instructions that, when run on processing means within a data receiving device, cause the data receiving device to perform said method.

### BRIEF DESCRIPTION OF THE DRAWINGS

In order that the invention may be more fully understood, embodiments thereof will now be described by way of example, with reference to the accompanying drawings in which:

FIG. 1 is a schematic block diagram of a mobile communications system comprising a digital broadcast network according to one embodiment of the invention;

FIG. 2 is a schematic block diagram of a mobile terminal configured to receive data from the digital broadcast network in the communication system of FIG. 1;

FIGS. 3 and 4 show a flowchart depicting a procedure performed by the mobile terminal of FIG. 2, for receiving and displaying content, according to one embodiment of the invention;

FIG. 5 depicts an example welcome page to an ESG application that may be displayed by the mobile terminal of FIG. 2;

FIG. 6 depicts an example service menu that may be displayed by the mobile terminal of FIG. 2;

FIG. 7 depicts an example notification message that may be displayed by the mobile terminal of FIG. 2; and

FIG. 8 is a flowchart showing part of a procedure for receiving and displaying content according to another embodiment of the invention.

### DETAILED DESCRIPTION

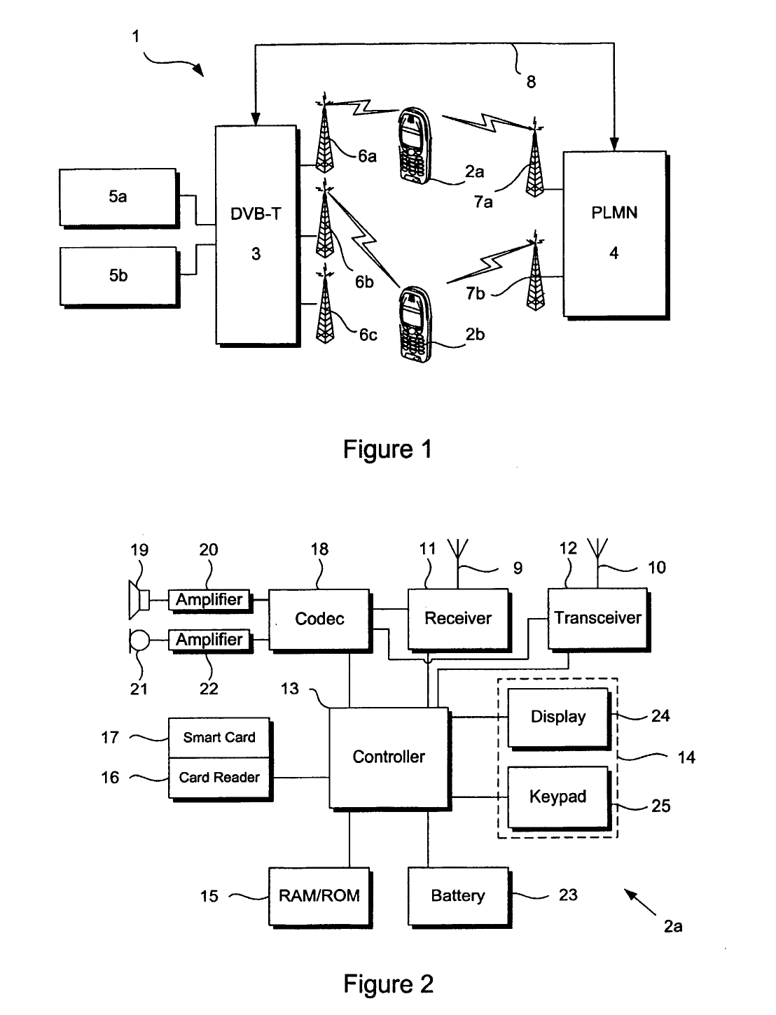

FIG. 1 illustrates schematically a communication system 1 in which mobile user equipment in the form of mobile terminals, such as telephone handsets 2a, 2b, are configured to receive transmissions from a digital broadcast network 3 which, in this particular example, is a DVB-T network, and to enable communication through a public land mobile network (PLMN) 4. The digital broadcast network 3 transmits content such as audiovisual content, visually displayable data, audio files or data files to the handsets 2a, 2b.

The content is obtained from data stream servers 5a, 5b in Internet protocol (IP) so that the network can provide an IP Datacast (IPDC) service over the digital broadcast network 3. Two such servers 5a, 5b are shown by way of example although in practice there may be many more. The stream servers 5a, 5b supply content in the form of IP datagrams. The datagrams are embedded into multi-protocol encapsulation (MPE) that are incorporated into MPEG-2 transport stream (TS) packets for broadcast by the digital broadcast network 3. For further details reference is directed to ETSI EN 301 192 V1.3.1 (2003-01) “Digital Video Broadcasting (DVB) DVB specification for data broadcasting” Section 7.

The digital broadcast network 3 is cellular and antennae 6a, 6b and 6c serve individual cells of the network 3 at geographically spaced sites.

The PLMN 4 may comprise any suitable 2 G, 2.5 G or 3 G network with antennae 7a, 7b that serve individual cells of the PLMN 4. A communication channel 8 may be provided between the digital broadcast network 3 and the PLMN 4 to allow bi-directional communication between the networks 3, 4, for example, for the interchange of service information.

FIG. 2 illustrates the circuits of a terminal 2a by way of a simplified example, in which the terminal 2a includes first and second antennae 9, 10, a receiver 11 and a transceiver 12. The first antenna 9 and receiver 11 are configured to receive signals from the digital broadcast network 3. The second antenna 10 and transceiver 12 are used to transmit and receive signals to and from the PLMN 4. RF signal processing circuits, not shown, are provided for amplifying and demodulating signals received by the receiver 11 and transceiver 12, together with processors, not shown, for channel de-coding and de-multiplexing.

The terminal 2a also includes a controller 13, a user interface 14, memory 15, a smart card reader 16, a smart card 17 received in the smart card reader 16, a coder/decoder (codec) 18, a speaker 19 with a corresponding amplifier 20 and microphone 21 with an associated preamplifier 22.

The terminal 2a is powered by a rechargeable battery 23.

The user interface 14 comprises a display 24 and keypad 25. The display 24 is configured with a resolution that is adequate for the display of images and video and may also be capable of displaying colour images.

The controller 13 manages operation of the terminal under the direction of computer software stored in memory 15, providing output for presentation on the display 24 and receiving user input from the keypad 25.

The terminal 2a has an electronic service guide (ESG), or media guide, application for displaying information relating to and providing access to services available over the digital broadcast network 3. For example, programme information, such as channel lists, current programs, recently viewed programs and available channels, can be accessed by a user through a system of one or more menus. The ESG application allows the user to select a service, such as a programme to view, and manages the reception and output of content relating to the selected service. The information relating to services may be broadcast over the digital broadcast network 3 for storage in the memory 15 of terminal 2a and updated and rebroadcast as required.

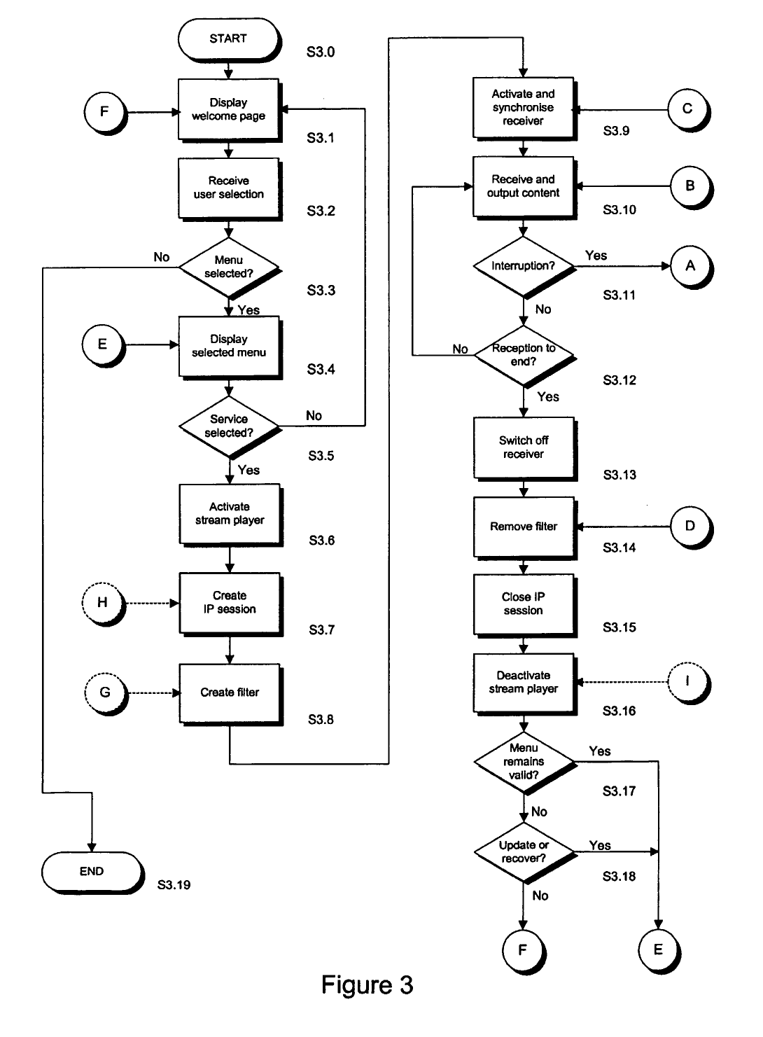

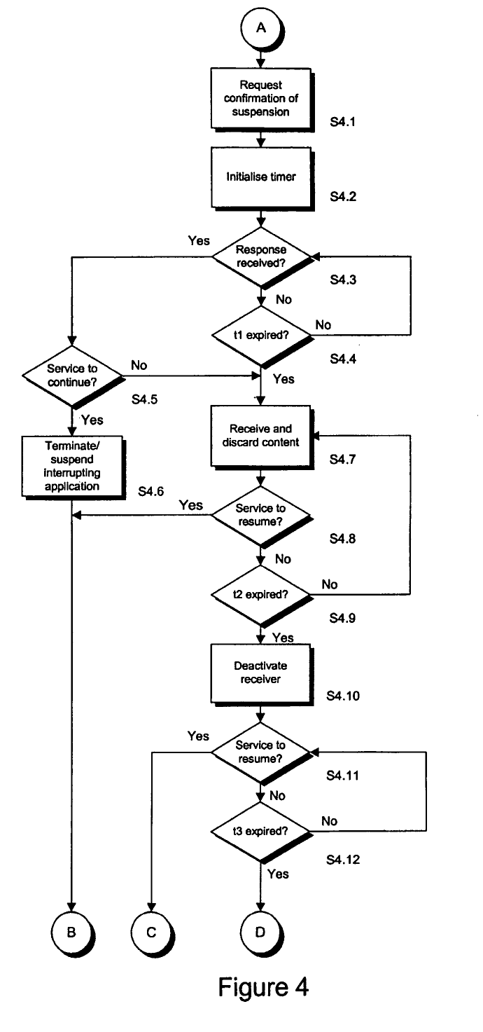

A procedure followed by an ESG application, according to one embodiment of the invention, will now be described with reference to FIGS. 3 and 4, beginning at step s3.0. The parts of FIG. 3 shown with dotted lines relate specifically to another embodiment of the invention, to be described later.

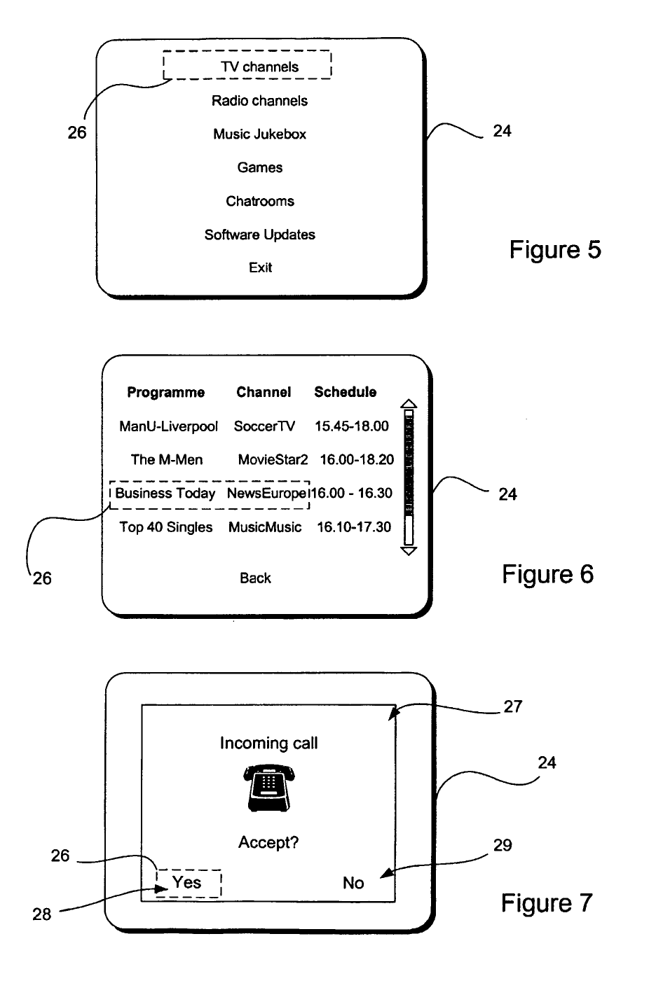

The ESG application is activated and, in this example, a welcome page is displayed on display 24 (step s3.1), which provides a number of options to the user, including display of one or more menus of available services. An example welcome page is shown in FIG. 5, in which options for viewing menus of different types of services, such as TV and radio channels, games, chatrooms and software updates are provided, along with an option to exit the ESG application.

In other embodiments of the invention, the welcome page may include a logo or other data associated with the ESG application and/or application provider instead of, or in addition to, the options shown in FIG. 5. Alternatively, another page or view within the ESG application, such as a sub-menu or a page relating to updated information or advertising a programme, may be displayed in place of a welcome page. In each case, a user can access one or more menus of services by selecting an appropriate option provided on the displayed page.

The user may select an option from the welcome page, or other displayed page, using keypad 25. In this particular example, a focus region 26 acts as a cursor. The user can select an option by moving the focus region 26 between the various options in the welcome page, using keypad 25, and pressing a designated key to select an option highlighted by the focus region 26.

When a selection is received (step s3.2), the controller 13 determines whether the user has requested to view a menu (step s3.3). If so, the appropriate menu is displayed (step s3.4), providing the user with a list of available services. In this particular example, a TV channels menu is selected and displayed as shown in FIG. 6, which lists programmes currently being transmitted over the digital broadcast network 3. The menu may include programme information, such as titles and times of transmission. The menu may be updated periodically from the ESG information stored by the terminal 2a. If it is no longer possible to maintain the menu, for example, if the displayed menu becomes obsolete, the ESG application may notify the user and/or return to displaying the welcome page on display 24 from which the user can select another menu to view or, alternatively, exit the ESG application.

The user may select a service from a displayed menu. In response to a selection (step s3.5), a stream player is activated (step s3.6) for outputting data from the service through the display 24 and, if required, speaker 19 and/or another audio output means, such as headphones or external speakers connected to, or in communications with, the terminal 2a. An application for de-encapsulating the extracted TS packets in order to retrieve the original IP datagrams is activated and an IP session for handling the IP datagrams is created (step s3.7). A filter is then created (step s3.8) at the receiver 11 for extracting TS packets relating to the selected service from a data stream broadcast over the digital broadcast network 3.

The receiver 11 is then switched into a reception mode (step s3.9) for receiving the data stream and is synchronised with the digital broadcast network 3. The terminal 2a can then receive and output content relating to the selected service (step s3.10) through its user interface 14.

If reception of the service is not interrupted (step s3.11), the reception and output of content (step s3.10) continues until reception is to end (step s3.12). For example, a service may be completed or an indication that the user no longer wishes to access the service may be received via keypad 25. The controller 13 deactivates the receiver 11 (step s3.13) and sends a “Remove Filters” command to the receiver 11, in response to which the filter is deleted (step s3.14). The IP session is closed (step s3.15) and the stream player deactivated (step s3.16).

The controller 13 then determines whether the most recently displayed menu, displayed at step s3.4, remains up to date (step s3.17). If so, the menu is displayed (step s3.4). The user may then access another service from the menu or, alternatively, the ESG welcome page. If the ESG welcome page (step s3.1) is displayed, the user may access another service via a second menu or, alternatively, exit the ESG application, completing the procedure (steps s3.2, s3.3, s3.19).

If it is determined that the menu is not up to date (step s3.17), the controller 13 ascertains whether the menu can be updated or recovered using service information stored in memory 15 and, in response to a positive determination, displays an updated or recovered menu (step s3.4), from which the user may access another service or the ESG welcome page. However, if it is not possible to update or recover the menu (step s3.17), for example, where the menu has become obsolete, a notification message may be displayed to inform the user of this, before displaying the welcome page (step s3.1). In either case, the user may access another service or exit the application as described (e.g. steps s3.2, s3.3, s3.19).

As noted above, the power consumption of the receiver 11, when receiving data (steps s3.10 to 3.12), may form a considerable proportion of the demand placed on the battery 23. Moreover, the controller 13 may be required to utilise and/or reserve a considerable proportion of available memory 15 for processing the TS packets and outputting content, particularly as the incoming data stream may have a high bit-rate. Should the terminal 2a be required to perform an unrelated function while data is being received and output, such as handling an incoming telephone call over PLMN 4, there may not be sufficient available resources available to accommodate both the ESG application and the unrelated function.

A procedure followed when the reception and output of content (steps s3.10 to s3.12) is to be interrupted will now be described, with reference to an example situation in which the terminal 2a is required to handle an incoming telephone call. However, an interruption may also occur if the user activates an unrelated application on the terminal 2a, for example, to inspect appointments stored using a calendar application, or where the user requests interruption of reception of the service in order to perform another activity away from the terminal 2a or while moving through an area in which the data stream cannot be received.

On reception of the incoming call (step s3.11), the controller 13 alerts the user to the incoming call, for example, using an audio notification and/or by displaying a notification message on the display 24. An example notification message 27 is shown in FIG. 7. The notification message 27 requests the user to indicate whether to proceed with the call and, therefore, whether access to the service is to be suspended (step s4.1). The user can respond to this request, selecting an option 28, 29 by positioning the focus region 26 using keypad 25 and pressing a designated key to select the highlighted option 28. In this particular example, the notification message 27 covers most or all of the display area and so the output of content through the stream player may be suspended while the notification message 27 is displayed. Alternatively, the controller 13 may be arranged to suspend output of visual content through the stream player while allowing audio output to continue.

In other embodiments of the invention, the notification message displayed over a smaller area of the display 24, for example, displayed over the output visual content and/or displayed in the form of a small icon. The notification message may also be displayed outside a frame within which the visual content is displayed. In these cases, the notification message or audio notification may be configured so that the user can continue viewing content while the notification message is displayed.

Where the interruption is caused by the running of another application, unrelated to the reception of data, a similar notification message, not shown, may be displayed in order to allow the user to indicate whether or not data reception is to be suspended.

The controller 13 initializes a timer in order to monitor the time t elapsed from the display of the notification message 27 (step s4.2). A predetermined period of time t1 is allowed for receipt of an indication from the user (step s4.3). Meanwhile, the various components and processes required for receiving, filtering, processing and outputting received data, including the receiver 11, filter, IP session and stream player, remain active. In this example, time period t1 is 4 seconds, although t1 may be set as a shorter or longer time period, for example, up to 10 seconds, as required.

If, before the expiry of time period t1 (step s4.4), that is, t<t1, the user indicates that the service is to continue (step s4.5), the unrelated application is terminated or suspended as appropriate (step s4.6). In this example, the incoming telephone call is rejected or diverted to a voicemail service. The data reception and output procedure continues as before (steps s3.10 to s3.12).

On the other hand, if the user wishes to suspend access to the service (step s4.5), in order to answer the incoming call, or if the controller 13 determines that time period t1 has expired (step s4.4), the ESG application operates in a resource saving mode.

When in resource saving mode, the receiver 11 continues to receive data but the received TS packets are discarded (step s4.7), without extracting or processing them, in order to reduce processing and memory requirements. The stream player application continues running in the background, while the incoming call is handled.

In another embodiment of the invention, the controller 13 may automatically perform steps s4.2, s4.7 without requesting confirmation from the user or providing an opportunity to terminate or suspend the unrelated application, for example, if the controller 13 determines that the available resources, such as power, memory and/or processing power, are insufficient to accommodate the service and the other application, or if the unrelated application is executed in response to an explicit request from the user. In such an embodiment, the controller 13 automatically initializes the timer (step s4.2) in response to the interruption and send an alert, such as an “Overloaded” message, to the receiver 11. On receipt of the alert, the receiver 11 begins discarding received TS packets (step s4.7), thereby freeing processing capacity for use in handling the telephone call.

The timer continues to monitor the time t elapsed and is used to determine whether this exceeds further predetermined time periods t2 and t3. In this particular example, t2 is 120 seconds and t3 is 300 seconds however, in other embodiments of the invention, t2 and t3 may be set at other values, if required. For example, t2 may be set at 60 seconds. The values of the second and third time periods t2, t3 may also be set in dependence on the type of application causing the interruption. In this example, where the interruption is a telephone call, it is possible that the duration of the call may be extremely short, for example, less than one minute, in which case the values above would be suitable. However, if the interruption is caused by an application that is activated by the user, different second and third time periods t2, t3 may be appropriate. For example, if the interruption is caused by the activation of a web browser within the mobile terminal 2a by the user, for example, by following a link provided in the ESG application in order to browse related content, the controller 13 may set the duration of one or both of the second and third time periods t2, t3 at longer periods, for example, 200 seconds and 600 seconds respectively.

If the telephone call is completed before expiry of time period t2, that is, t1≦t≦t2, the user's access to the service may be resumed (step s4.8) in the following manner. The ESG application resumes normal operation. The resumption may be automatic on completion of the unrelated application, that is, when the user ends the telephone call or closes a window presented on display 24 that is associated with it, or by the user manually reactivating the ESG application from, for example, an applications menu displayed by the terminal 2a. The controller 13 simply restarts processing of received TS packets and output of content (steps s3.10 to s3.12). As the receiver has continued to receive TS packets from the digital broadcast network 3 (step s4.7) throughout time period t2, access to the service may be achieved rapidly and straightforwardly, as it is not necessary to resynchronise the receiver 11 with the digital broadcast network 3.

However, if access to the service is not resumed before time period t2 has elapsed (step s4.9), i.e. t>t2, the receiver 11 is automatically switched into an inactive mode (step s4.10) to conserve power, for example, on receipt of a “Sleep” command sent by the controller 13.

Where time period t2 has expired but time period t3 has not yet elapsed, that is, t2≦t≦t3, access to the service may be resumed (step s4.11) as follows. As in the previous scenario, the ESG application may resume normal operation automatically on completion of the unrelated application, for example, on disconnection of a telephone call with a duration greater than time period t2 but less than time period t3, or by the user selecting the ESG application from the applications menu. The receiver 11 is then reactivated, on receipt of a “Wakeup” command from the controller 13, and resynchronised with the network (step s3.9). The reception and output of content then continues as before (steps s3.10 to s3.12).

If access to the service is not resumed before time period t3 expires (at step s4.12), i.e. t>t3, the stream player is deactivated (step s3.14), the IP session is closed (step s3.15) and the filters are removed (step s3.16). The menu is then displayed (step s3.4), following any necessary updating or recovery (step s3.17, s3.18).

Alternatively, if the menu has become obsolete or out of date and cannot be updated or recovered (steps s3.17, s3.18), the welcome page is displayed (step 3.1). The user may then access another service or exit the ESG application as described above.

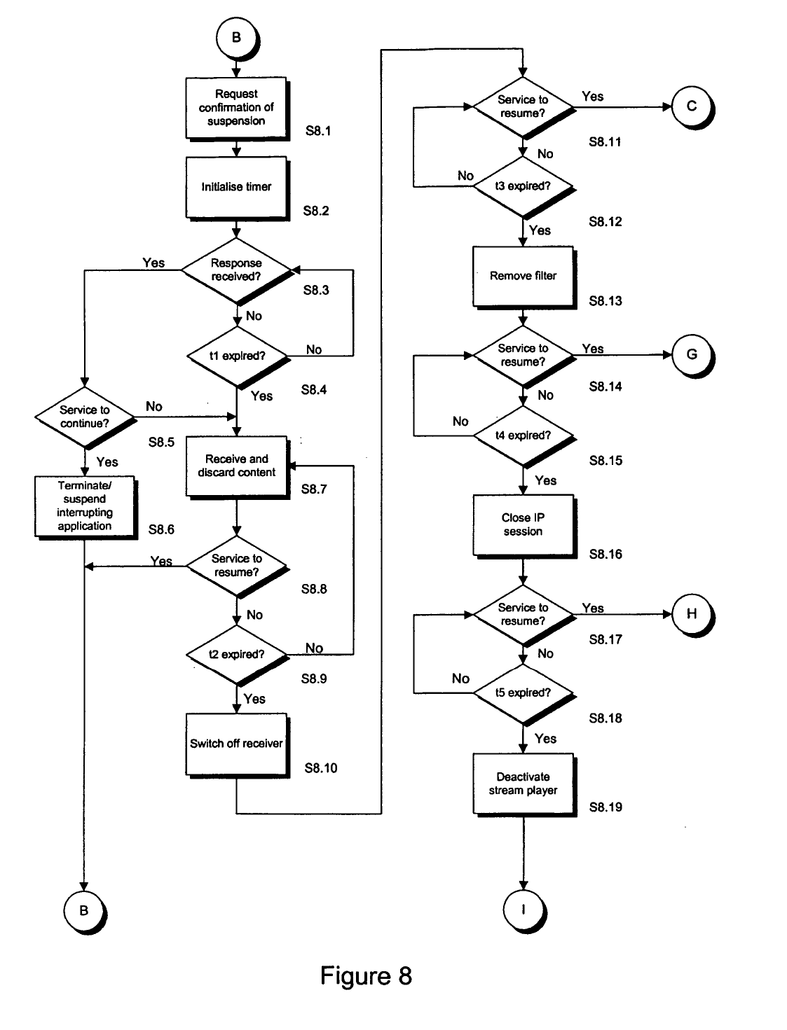

In another embodiment of the invention, the ESG application may follow another procedure will now be described with reference to FIGS. 3 and 8, in which the various components and processes required for reception of the service from the DVB-type network 3 are deactivated in stages.

Through this procedure, a service can be selected and accessed as shown in steps s3.0 to s3.12 and, in response to an interruption, the procedure follows steps s8.1 to s8.10 that correspond to steps s4.1 to s4.10 as described in relation to the previous embodiment. In other words, following an interruption, confirmation is requested from the user that the service is to be suspended (step s8.1) and a timer is initialized (step s8.2).

The timer is used to determine whether the time t elapsed from the display of the notification message (step s8.1) or, where the service is to be suspended automatically, without confirmation from the user, from the interruption, exceeds one or more predetermined time periods t1 to t5. In this particular example, t1 is set to 4 seconds and t2 to t5 set to 120 seconds, 300 seconds, 450 seconds and 600 seconds respectively, although the chosen time periods t1 to t5 may be set at other values in other embodiments of the invention and/or in dependence on the cause of the interruption, as described above in relation to the first embodiment.

If the user wishes to suspend the service (step s8.5) or if time period t1 expires before the user has responded to a notification message (step s8.4), data continues to be received by receiver 11 but is discarded without being processed or output (step s8.7). Following the expiry of second time period t2, the receiver 11 may be deactivated in order to conserve power (step s8.10). The service may then be resumed (step s8.11), where t2≦t≦t3, either automatically on completion of an application causing the interruption or on receipt of a request for resumption from the user. The receiver 11 is then reactivated and synchronised with the DVB-type network 3 (step s3.9) and data reception resumes (steps s3.10 to s3.12).

However, if the service is not resumed before the expiry of third time period t3 (step s8.12), that is, t>t3, the filter is deleted by sending a “Remove filters” command from the controller 13 to the receiver 11 (step s8.13). If the user then requests resumption of the service (step s8.14), before the expiry of the fourth time period t4, i.e. t3≦t≦t4, a new filter is created (step s3.8), the receiver 11 is activated and resynchronised (step s3.9) and data reception continues (steps s3.10 to s3.12).

Should the fourth time period t4 expire (step s8.15) without resumption of the service, the IP session is closed (step s8.16). If the user subsequently wishes to return to the service (step s8.17) before the expiry of fifth time period (step s8.18), i.e. t4≦t≦t5, a new IP session must be created (step s3.7), along with a new filter (step s3.8) and reactivation and resynchronization of the receiver 11 (step s3.9) before data reception resumes (steps s3.10 to s3.12).

If the service is not resumed before the fifth time period t5 expires (step s8.18), the stream player is deactivated (step s8.19).

Following deactivation of the stream player (step s8.19), the menu, following any necessary updating or recovery (steps s3.17, 3.18) or welcome page is displayed (step s3.4 or s3.1) as described in relation to the first embodiment. The user may then access another service or exit the ESG application, completing the procedure (step s3.19).

In the above described embodiments, the terminal 2a is configured so that received data is discarded while t1≦t≦t2. However, in another embodiment of the invention, the terminal 2a may be arranged so that, instead of being discarded, received data is stored in memory 15. This allows the user to view and/or listen to content broadcast during the interruption, for example, if an interruption occurs towards the end of a scheduled programme or during broadcast of a live event. The terminal 2a may be arranged so that, following suspension, i.e. in response to expiry of first time period t1 at step s4.4 or reception of an indication from the user that the service is to be suspended at step s4.5, received data is stored without being processed or output up to a time limit t′. Thereafter, received data is discarded (step s4.7) until the service is resumed (step s4.8) or time period t2 expires (step s4.9). The time limit t′ may be pre-set by the controller 13 or set manually by the user when confirming suspension of the service (step s4.5).

Although, in the procedure shown in FIG. 8, time periods t2, t3, t4 and t5 are of different lengths, two or more of these time periods t2 to t5 may be set to identical values, if required.

While the embodiments described above relate to services broadcast over a DVB-T network 3, the invention may be implemented in systems comprising other types of digital broadcast network, for example, networks according to DVB-S, DVB-H, Integrated Services Digital Broadcasting (ISDB) or Advanced Television Standards Committee (ATSC) standards.

Furthermore, the invention has been described by way of an example in which IPDC services are provided to mobile terminals 2a, 2b. However, the invention may be used in the distribution of content and digital rights to personal digital assistants (PDAs), laptop computers or other devices arranged to receive data from a digital broadcast network in addition to, or instead of, one or more mobile terminals 2a, 2b.

1-17. (canceled)

18. A method of receiving data comprising:
receiving data from a broadcast network;
processing the received data;
outputting the processed data; and
in response to an interruption, proceeding in a first resource saving mode by continuing to receive data from the broadcast network but not processing and not outputting said received data.

19. A method according to claim 18, wherein, when in said first resource saving mode, received data is discarded.

20. A method according to claim 18, wherein, when in said first resource saving mode, received data is stored.

21. A method according to claim 20, comprising, in the first resource saving mode, discarding data received following the expiry of a predetermined time limit.

22. A method according to claim 19, comprising, after operating in said first resource saving mode for a first predetermined time period, proceeding in a second resource saving mode in which no data is received from the broadcast network.

23. A method according to claim 22, wherein the step of receiving data from the broadcast network comprises filtering the received data in order to discard unwanted data.

24. A method according to claim 23, wherein, after operating in said second resource saving mode for a second predetermined time period, removing a filter arranged to perform said filtering step.

25. A method according to claim 22, 23 or 24, wherein, after operating in said second resource saving mode for a third predetermined time period, an IP session arranged to handle the output data is closed.

26. A method according to claim 22, wherein, after operating in said second resource saving mode for a fourth predetermined time period, an application for outputting the processed data is deactivated.

27. A method according to claim 19, wherein the interruption is an activation of an application unrelated to reception of data from the broadcast network.

28. A method according to claim 27, which proceeds in said first resource saving mode in response to a determination that insufficient resources are available for handling reception of data and the unrelated application.

29. A method according to claim 19, comprising displaying a list of services provided over the broadcast network.

30. A method according to claim 29, comprising updating said list of services and displaying an updated list.

31. A method according to claim 19, wherein the step of outputting comprises at least one of: displaying visually displayable data; and outputting audio data.

32. A computer program comprising instructions that, when run on processing means within a data receiving device, causes said data receiving device to perform a method according to claim 19.

33. A data receiving device comprising:
a receiver arranged to receive data from a broadcast network;
a processor arranged to process the received data; and
output means configured to output processed data; the data receiving device being arranged to operate in a first resource saving mode in which the receiver remains active but received data is not processed by the processor and not outputted by the output means.

34. A data receiving device according to claim 33, wherein, in said first resource saving mode, the received data is discarded.

35. A data receiving device according to claim 33, wherein, in said first resource saving mode, the received data is stored.

36. A data receiving device according to claim 35, wherein, in the first resource saving mode, data received following the expiry of a predetermined time limit is discarded.

37. A data receiving device according to claim 33, configured to, after operating in said first resource saving mode for a first predetermined time period, operate in a second resource saving mode in which the receiver is deactivated and the processor and output means remain operational.

38. A data receiving device according to claim 37, wherein the receiver comprises a filter configured to extract selected data from the received data for processing, the receiver being configured to deactivate the filter after operating in said second resource saving mode for a second predetermined time period.

39. A data receiving device according to claim 37, wherein the processor is configured to create an IP session for handling the output data, and, after operating in said second resource saving mode for a third predetermined time period, to close said IP session.

40. A data receiving device according to claim 37, configured to, after operating in said second resource saving mode for a fourth predetermined time period, deactivate an application configured to output the processed data via the output means.

41. A data receiving device according to claim 33, configured to operate in said first resource saving mode following an interruption.

42. A data receiving device according to claim 41, wherein the interruption is an activation of an application unrelated to reception of data from the broadcast network.

43. A data receiving device according to claim 42, configured to switch to said first resource saving mode in response to a determination that insufficient resources are available for handling reception of data and the unrelated application.

44. A data receiving device according to claim 33, further comprising a telephone transceiver arranged to transmit and receive data via a telecommunications network.

45. A data receiving device according to claim 33, comprising a media guide application to selectively access services provided over broadcast network.

46. A data receiving device according to claim 45, wherein the media guide application is configured to display and update a list of available services on a user interface of the receiving device.

47. A data receiving device according to claim 33, wherein the output means comprises at least one of: a display for outputting visually displayable data; and audio output means.

48. A communication system comprising:
a broadcast network; and
one or more receiving devices according to claim 33.

49. A communication system according to claim 48, comprising:
a bi-directional telecommunications network;
wherein at least one of the one or more receiving devices comprises a telephone transceiver arranged to transmit and receive data via said telecommunications network.
